(19) United States
(12) Patent Application Publication
(10) Pub. No.: US 2015/0178659 A1
(43) Pub. Date: Jun. 25, 2015

(54) Method and System for Identifying and Maintaining Gold Units for Use in Crowdsourcing Applications

(71) Applicants: Peng Dai, Mountain View, CA (US); Owen Brydon, Mountain View, CA (US)

(72) Inventors: Peng Dai, Mountain View, CA (US); Owen Brydon, Mountain View, CA (US)

(73) Assignee: GOOGLE INC., Mountain View, CA (US)

(21) Appl. No.: 13/418,485

(22) Filed: Mar. 13, 2012

(51) Int. Cl. G06Q 10/06; G06Q 50/00

(52) U.S. Cl. CPC G06Q 10/06395; G06Q 50/01

(57) ABSTRACT

Methods and systems for identifying and maintaining gold units in a crowdsourcing application are provided. Units of work are selected for inclusion in a gold set based on worker responses to the units of work and an accuracy associated with the workers responding to the unit of work. The gold set is dynamically updated to remove older gold units from the gold set and to remove gold units that are too subjective from the gold set. The optimum gold unit percentage for a given task can also be identified.

### FIELD

The present disclosure relates generally to crowdsourcing and more particularly, to identifying and maintaining gold units for quality control in crowdsourcing applications.

### BACKGROUND

Crowdsourcing has become increasingly used to outsource a variety of tasks, typically in the form of an open call, for completion by large groups of people. With the advance of the Internet, crowdsourcing services can provide online marketplaces where businesses and other entities can submit tasks for completion by thousands of workers online. For instance, crowdsourcing markets, such as the Mechanical Turk crowdsourcing market by Amazon.com Inc., offer thousands of human workers with differing expertise to complete a variety of tasks on call. By crowdsourcing tasks to a large group of human workers, crowdsourcing can provide a cost effective method for a business or other entity to use the collective intelligence of the general public to complete or solve a given task.

Quality control is an important problem for crowdsourcing applications given that thousands of workers can submit responses to a given task through a typically open participation model. One known technique for assessing the quality or integrity of a worker is through the use of gold units. Gold units are units of work for a given task with known correct responses that are periodically provided to a worker during the performance of the task to assess the performance of the worker. The accuracy of a worker can be estimated based on the number of gold units responded to correctly. If a particular worker provides correct responses to a large number of gold units during the performance of a task, then the responses provided by that particular worker can generally be relied on as accurate. However, if the particular worker fails to provide correct responses to a large number the gold units, the worker's responses can be discarded as unreliable.

The use of gold units for quality control can suffer several drawbacks. For instance, the generation of gold units can be very expensive, typically requiring experts and/or sophisticated mechanisms for labeling gold units. Also, many tasks may be considered too subjective and unsuitable for gold units. Furthermore, a static set of gold units for a given task leaves chances for strategic workers/spammers to game the system. A worker/spammer who learns the correct responses to the gold units can answer all of the gold units correctly and answer the rest of the units of work randomly while still being mistakenly recognized as a perfect worker.

### SUMMARY

Aspects and advantages of the invention will be set forth in part in the following description, or may be obvious from the description, or may be learned through practice of the invention.

One exemplary aspect of the present disclosure is directed to a computer-implemented method of identifying gold units for quality control in crowdsourcing applications. The method includes receiving a plurality of responses to a unit of work for a task and selecting the unit of work for inclusion in a gold set based at least in part on the responses provided to the unit of work and an accuracy associated with workers completing the unit of work.

Another exemplary aspect of the present disclosure is directed to a computer-implemented method of maintaining a dynamic gold set. The method includes monitoring responses to a gold unit from a plurality of workers and determining a subjectiveness metric of the gold unit based on the responses to the gold unit. The subjectiveness metric provides a measure of the divergence of the responses to the gold unit from the plurality of workers. The method further includes removing the gold unit from a gold set based at least in part on the subjectiveness metric.

Yet another exemplary aspect of the present disclosure is directed to a computer-implemented method of maintaining a dynamic gold set. The method includes maintaining a first gold unit percentage for a task for a first period of time; monitoring the accuracy of the task for the first period of time; adjusting the first gold unit percentage to a second gold unit percentage; maintaining the second gold unit percentage for the task for the second period of time; monitoring the accuracy of the task for the second period of time; and adjusting the gold unit percentage used in the task based on the difference between the accuracy of the task for the first period of time and the accuracy of the task for the second period of time.

Other exemplary implementations of the present disclosure are directed to systems, apparatus, computer-readable media, and other devices for identifying and maintaining gold units for quality control in crowdsourcing applications.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts an overview of an exemplary crowdsourcing system according to an exemplary embodiment of the present disclosure;

FIG. 2 depicts a flow diagram of an exemplary method for identifying a gold unit according to an exemplary embodiment of the present disclosure;

FIG. 3 depicts a flow diagram of an exemplary method for maintaining a dynamic gold set according to an exemplary embodiment of the present disclosure;

FIG. 4 depicts a flow diagram of an exemplary method for maintaining a dynamic gold set according to an exemplary embodiment of the present disclosure;

FIG. 5 depicts a flow diagram of an exemplary method for determining an optimum gold unit percentage for a task according to an exemplary embodiment of the present disclosure; and

FIG. 6 depicts a block diagram of an exemplary crowdsourcing system according to an exemplary embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to computer-based methods and systems for identifying and maintaining gold units for use in crowdsourcing applications. In particular, units of work can be automatically selected for inclusion in a gold set based on worker responses to the units of work and an accuracy associated with the workers responding to the unit of work. The gold set can be dynamically updated to remove older gold units from the gold set and to remove gold units that are too subjective from the gold set. In addition, an optimum gold unit percentage for a particular task can be automatically identified based on an accuracy associated with the given task.

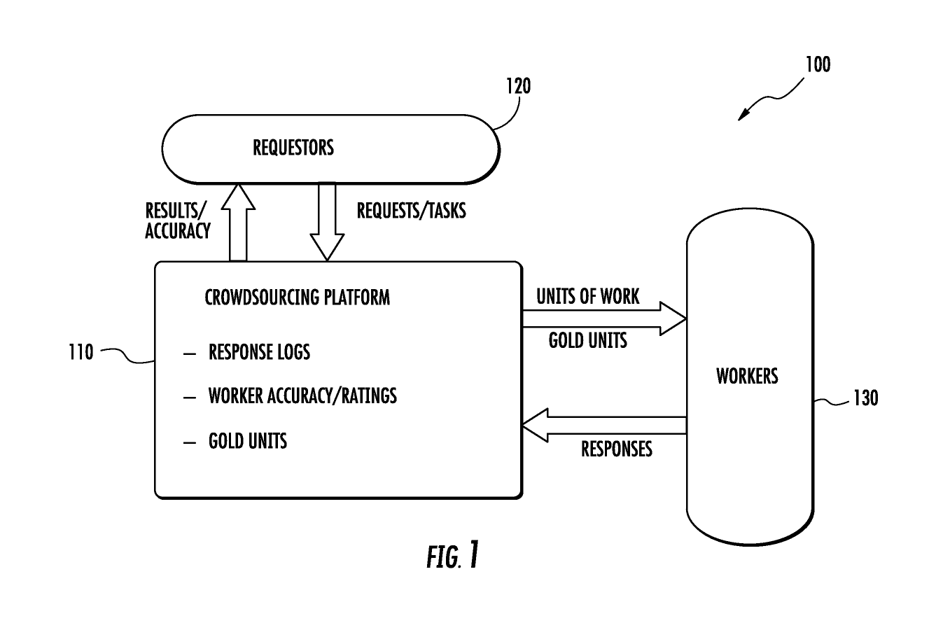

FIG. 1 depicts an overview of an exemplary crowdsourcing system 100 according to an exemplary aspect of the present disclosure. The crowdsourcing system 100 includes a crowdsourcing platform 110 that receives requests from businesses and other entities, collectively referred to as requestors 120, for tasks to be crowdsourced to workers 130 pursuant to a typically open call for responses. Exemplary tasks can include annotating images, verifying data, data collection or compilation, translating passages and/or other materials, verifying search results, or other tasks. Those of ordinary skill in the art, using the disclosures provided herein, should understand that the present invention is not limited to any particular task or request.

A crowdsourced task can include a plurality of units of work that make up the task. The units of work are individual subsets of the task to which a worker can provide a response. A task can include a single unit of work or many thousands of units of work depending on the nature of the task. For instance, a task directed to generating a logo for a new product could include a single unit of work—the design of the logo. A task directed to, for instance, annotating images, translating documents, and/or verifying search results can include many units of work. For instance, each image or other data that requires annotation can be considered a unit of work for the task.

The crowdsourcing platform 110 can provide individual units of work for the task to workers 130 for completion. The units of work can be provided to the workers 130 in duplicate to achieve a desired accuracy level for the task. The workers 130 can complete the task by providing responses to the units of work to the crowdsourcing platform 110. The worker responses can be logged at the crowdsourcing platform 110 and provided to the requestor 120. A reward or compensation can be provided to the worker 130 for completing the units of work. The reward or compensation provides an incentive for the workers 130 to complete the tasks.

Given the open nature of responses to crowdsourced tasks, the crowdsourcing platform 110 needs to track or estimate the worker accuracy of the responses provided by the workers 130. The worker accuracy associated with the workers 130 can be used to filter out responses from unreliable workers or to provide certain tasks only to workers that meet a threshold level of accuracy. For instance, the crowdsourcing platform 110 can track the accuracy of a worker during completion of the task. If the accuracy of the worker falls below a certain threshold, the worker can be prevented from performing further units of work for the task.

Gold units provide a mechanism for the crowdsourcing platform 110 to track the accuracy of the workers 130. A gold unit is a unit of work with a known correct response that is provided to a worker to assess the accuracy of the worker. During the completion of a task, a certain percentage of the units of work provided to the worker are gold units. This percentage will be referred to as the gold unit percentage for a given task. The number of gold units responded to correctly by the worker provides a measure of the accuracy of the worker. For instance, if the worker responds to 9 out of 10 gold units correctly, the worker can be estimated to have an accuracy of about 90%. If the worker responds to 4 out of 10 gold units, the worker can be estimated to have an accuracy of about 40%.

In particular implementations, the gold units can provide a vehicle for training the workers for a given task. For instance, if a worker answers a gold unit incorrectly, the crowdsourcing platform can provide a training module to the worker informing the worker that the response provided was incorrect and instructing the worker on steps to be taken to avoid an incorrect response in the future.

The crowdsourcing platform 110 can also provide for the rating of workers 130 by the requestors 120. For instance, requestors 120 can assign a qualification-type score or rating to individual workers based on the worker's performance or accuracy during a particular task. The score or rating can be used as a threshold to constrain workers who can work on a task. For instance, a task hierarchy can be built for a given task based on the score or rating assigned to the individual workers 130. The task hierarchy can allow all workers 130 to work on less knowledge-demanding tasks. After certain workers have established their proficiency, the workers can be granted access to work on more demanding or challenging tasks. The task hierarchy can be maintained invisible to workers 130 and can provide an effective tool for routing more advanced tasks to the most competent workers 130.

Aspects of the present disclosure are directed to automatically identifying and maintaining gold units to assess the accuracy of workers in a crowdsourcing application. In one particular aspect, the responses provided to units of work that form a part of a given task are analyzed to identify units of work that can be used as gold units. In particular, the consensus level of a unit of work (i.e. the amount the workers agree on a response to a unit of work) can be assessed based on responses provided by the workers. If the consensus level of a unit of work achieves a certain threshold, the unit of work can be selected for inclusion in a gold set for the task.

In a particular implementation, the consensus level for the unit of work is enforced using a confidence level for the unit of work. The confidence level for the unit of work provides a measure of the probability that the most common response to the unit of work is the correct solution. The confidence level of the unit of work is determined based at least in part on an accuracy associated with workers providing a response to the unit of work. The accuracy can be an average accuracy or can be individual accuracies associated with workers completing the unit of work. If the task is a relatively new task such that no worker accuracy information is available, the accuracy information can be based on worker accuracies or ratings from similar tasks.

A unit of work with a high confidence level has a high probability that the most common answer to the unit of work is correct. The unit of work can thus be suitable for use as a gold unit. According to aspects of the present disclosure, if the confidence level of a unit of work exceeds a predefined threshold, the unit of work can be selected for inclusion in the set of gold units or gold set for the particular task. In this manner, a gold set can be automatically generated or identified based on worker responses to units of work without incurring the significant costs of experts or manual labeling of work units as gold units.

According to another particular aspect of the present disclosure, the gold set is dynamically updated to keep workers from the gaming the system. For instance, a gold unit in the gold set can be replaced with a new gold unit every time a unit of work is selected for inclusion in the gold set based on the confidence level of the unit of work. In other implementations, a gold unit can be removed from the gold set after the gold unit has been a part of the gold set for a predefined period of time or after the gold unit has been provided to workers a predetermined number of times. The gold units can be replaced with newly identified gold units. If no gold units are available, units of work that are close to achieving gold unit status can be proactively polled so that gold units become available to replace older gold units.

According to another particular aspect of the present disclosure, the subjectiveness of the gold units is assessed to remove any gold units from the gold set if the gold unit is determined to be too subjective for use as a gold unit. For instance, statistical analysis can be performed on the responses to the gold unit to assess the divergence of the responses to the gold unit. If the responses to the gold unit become too divergent, the gold unit can be flagged as subjective and removed from the gold set.

Yet another exemplary aspect of the present disclosure is directed to maintaining an optimum gold unit percentage for a task. Collecting responses to gold units does not contribute to the productivity of the crowdsourced task. Too many gold units can decrease throughput and waste resources. Moreover, it can annoy diligent workers when the workers are continuously presented with repeated units of work. Too few gold units can be less effective at maintaining the integrity of worker responses, especially when a spammer takes only a few tasks and escapes supervision.

According to a particular aspect of the present disclosure, an optimum gold unit percentage for a given task is determined by maintaining a first gold unit percentage for a first period of time and monitoring the accuracy of responses during the first period. The gold unit percentage can then be adjusted to a second gold unit percentage for a second period of time. The accuracy of responses during the second period can be monitored and compared to the accuracy of responses during the first period. The accuracy change can be used to adjust the gold unit percentage either up or down until an optimum gold unit percentage is achieved.

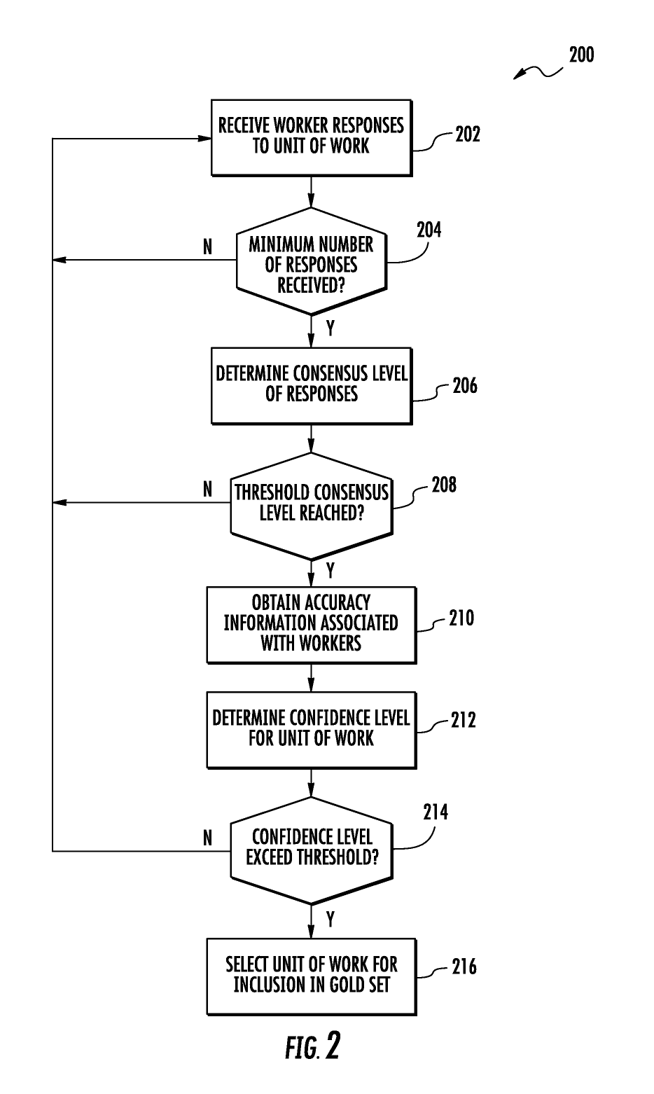

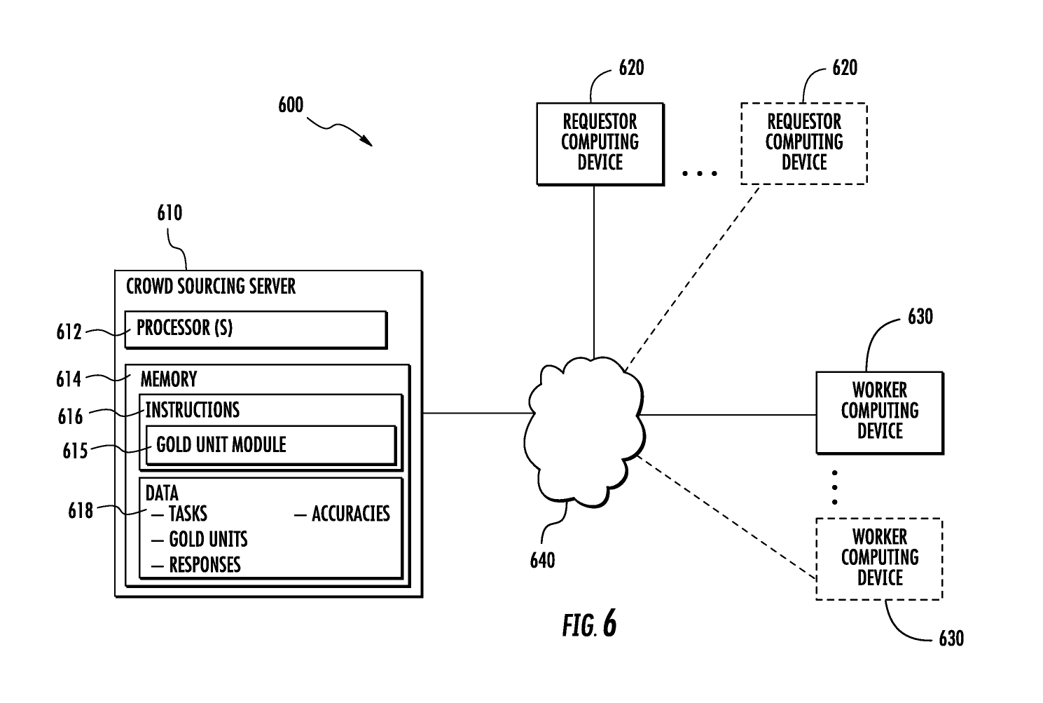

With reference now to FIGS. 2-5, exemplary methods for identifying and maintaining gold units according to exemplary embodiments of the present disclosure will be discussed in detail. The methods discussed herein can be implemented by a processor of a computing device to automatically identify gold units and maintain a dynamic gold set. An exemplary crowdsourcing system for implementing the methods will be discussed with reference to FIG. 6 below. In addition, although FIGS. 2-5 depict steps performed in a particular order for purposes of illustration and discussion, the methods discussed herein are not limited to any particular order or arrangement. One skilled in the art, using the disclosures provided herein, will appreciate that various steps of the methods can be omitted, rearranged, combined and/or adapted in various ways.

FIG. 2 depicts an exemplary method for generating or identifying gold units according to an exemplary embodiment of the present disclosure. At (202), worker responses to a unit of work are received for a given task. In particular, a single unit of work can be provided to a plurality of different workers in duplicate to achieve a desired accuracy level for the task. Each of the plurality of different workers can provide a response to the unit of work. The method 200 analyzes the responses given by the workers to the unit of work to determine if the unit of work is suitable for use as a gold unit.

At (204), it is determined whether a minimum number of worker responses to a unit of work have been received so that analysis of the worker responses can be properly performed. The minimum number of worker responses can be set to any level, depending on the nature of the task and other parameters of the crowdsourcing application. In an exemplary implementation, the minimum number of worker responses can be in the range of about 2 to about 5 worker responses, such as about 3 worker responses. If the minimum number of worker responses to a unit of work has not been received, worker responses are continued to be received until the minimum number is achieved.

Once the minimum number of worker responses is achieved, the method determines the consensus level of the worker responses (206). The consensus level of the worker responses provides a measure of the degree to which the workers agree on a response to the unit of work. The consensus level of the unit of work can be expressed or determined in any suitable fashion. For instance, the consensus level of the unit of work could be expressed as a percentage, ratio, or probability of the number of responses to a unit of work that agree relative to the total number of worker responses to the unit of work.

A unit of work is suitable for use as a gold unit only if a relatively high number of workers agree on a response to the unit of work. Otherwise the unit of work may be too subjective for use as a gold unit. In this regard, the method at (208) determines whether the responses to the unit of work have a threshold consensus level. The threshold consensus level can be set to be any particular level depending on the type of task and other parameters. In a particular implementation, the threshold consensus level is set such that the all worker responses to the unit of work are required to be unanimous—i.e. the unit of work has a unanimous answer set. If the desired consensus level is not reached for a particular unit of work, the method 200 continues to receive worker responses until the threshold level is achieved. In certain cases, it can become statistically impossible for a unit of work to achieve the required consensus level. In these cases, the unit of work will never be selected for inclusion in the gold set.

In addition to the unit of work having a desired consensus level, it is also desirable for the responses provided to the unit of work by the workers to be the correct responses. If the most common solution to a unit of work is wrong or comes from unreliable workers, the unit of work should not be selected for inclusion in a gold set. The confidence level of a unit of work provides a measure that can be used to assess the reliability of the most common solution to a unit of work. In particular, the confidence level of the unit of work is a measure of the probability that the most common response to the unit of work is the correct response for the unit of work and is typically provided as a probability measurement between the values of 0 and 1. The higher the confidence level, the more likely the most common response to the unit of work is correct. According to particular aspects of the present disclosure, the confidence level is determined based at least in part on an accuracy associated with workers completing the unit of work.

For instance, at (210) the method includes obtaining accuracy information associated with the workers. In one aspect, the accuracy information can include individual accuracies a₁, a₂, a₃, . . . aₙ associated with individual workers completing the unit of work. As an example, if three individual workers completed a unit of work for the task, the accuracies associated with the workers can be individual worker accuracies a₁, a₂, a₃. The individual accuracies can provide a measure of the probability that the response provided by the particular worker is correct and can be computed using any known technique.

In one example, the individual worker accuracies are determined using worker responses to preexisting gold units. For instance, if a worker had previously answered 9 out of 10 gold units correctly, the worker can have an individual accuracy of about 0.9 or about 90%. Alternatively, a worker accuracy associated with a related or similar task can be used when worker accuracy based on gold units is not yet available.

The accuracy information associated with the workers can also be can be an average accuracy a for all workers completing the unit of work. The average accuracy a can be computed according to any technique. For instance, the average accuracy a can be the mean, median, or mode of the individual accuracies associated with workers completing the unit of work. The accuracy associated with the workers can be updated periodically or can be updated in real time as the workers provide responses to the units of work for the task.

For new tasks, accuracy information may not be available due to the lack of responses for the new task. In these cases, accuracy information can be bootstrapped based on worker accuracies associated with related tasks or based on worker ratings maintained by the crowdsourcing system. For instance, worker ratings can serve as the foundation for computing the confidence level of a particular unit of work. As more and more gold units become available for the task, accuracy information can be based on worker responses to the gold units for the task.

Once the worker accuracy information has been obtained, the method 200 can calculate a confidence level for the unit of work (212). As set forth above, the confidence level provides a measure of the probability that the most common response to the unit of work is the correct response. The confidence level can be computed using any known statistical analysis techniques based on the accuracy information associated with the workers.

In one example, the confidence level can be calculated based on the average accuracy a of all workers completing the unit of work. If the average accuracy a is expressed as a probability between 0 and 1, the confidence level of the unit of work could be equal to the average accuracy a for all workers completing the unit of work. In this example, if the average accuracy a is relatively high, it is more likely that the most common solution to the unit of work is correct and is suitable for use as a gold unit. If the average accuracy is relatively low, it is more likely that the most common solution is incorrect and the unit of work may not be suitable for use as a gold unit.

In another example, the confidence level can be calculated based on the individual accuracies associated with the workers completing the unit of work. For instance, the confidence level can be calculated based on individual accuracies using a Noisy-Or model. In particular, if the threshold consensus level requires a unanimous answer set and the individual worker responses are assumed to be independent of each other, the confidence level can be computed according to the following:

Confidence Level=1−(Πₖ₌₁ⁿ(1−aₙ))

As an example, a unit of work can receive unanimous answers from three workers with accuracies a₁, a₂, a₃. The confidence level for this example can be computed as 1−(1−a₁)(1−a₂)(1−a₃). Other statistical analysis techniques can be used to determine a confidence level for a non-unanimous answer set. While the Noisy-Or model calculation can be suitable for use with units of work with binary or Boolean responses, it should be noted that the Noisy-Or model can also be extended to provide a confidence level measure for units of work that with more than two potential responses.

Once the confidence level has been determined, the method determines whether the confidence level exceeds a predetermined threshold (214). If the unit of work meets the requisite confidence level, the unit of work is selected for inclusion in the gold set (216). If the unit of work does not meet the requisite confidence level, the method continues to receive worker responses to the unit of work until the desired confidence level is achieved, if at all. In this manner, the method 200 provides for the automatic generation or identification of gold units based on worker responses to units of work for a given task. The automatic identification of gold units can save significant expense associated with the traditional identification of gold units for crowdsourcing applications.

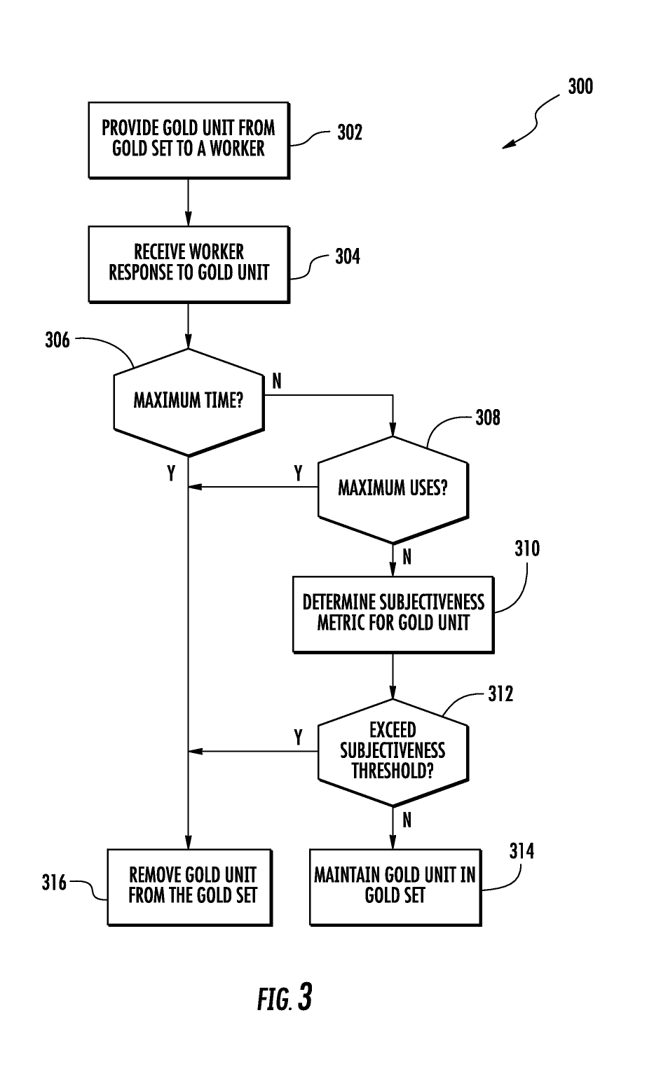

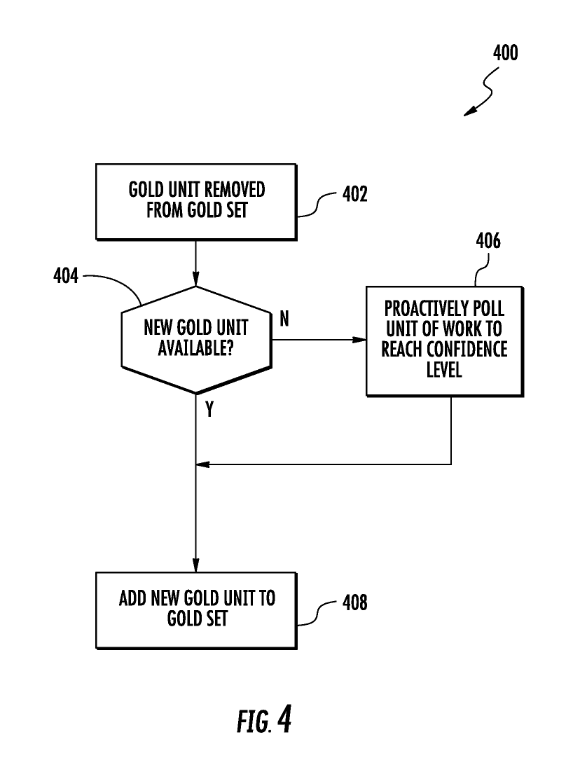

Referring to FIGS. 3 and 4, exemplary methods for maintaining a dynamic gold set for a particular task will be discussed in detail. A gold set is the set of all gold units available for use in a given task. Gold units in the gold set are periodically provided to a worker during the performance of a task to assess the accuracy/quality of the worker. It is desirable to maintain a dynamic gold set to prevent workers from learning the identity of gold units and gaming the system.

FIG. 3 provides a flow diagram of an exemplary method 300 for determining when to remove a gold unit from a gold set. The method 300 can be used to achieve two primary objectives. First, the method 300 can be used to prevent spammers from learning the identity of gold units and gaming the system by removing older gold units from the gold set after the gold unit has been in the gold set for a predetermined period of time or after the gold unit has been used a predetermined number of times. Second, the method 300 can be used to reduce the subjectiveness of gold units by removing gold units that are deemed to be too subjective from the gold set.

Referring to FIG. 3 at (302), the method 300 provides a gold unit from the gold set for the task to one or more workers for a response. At (304), the one or more workers provide a response to the gold unit. The method 300 can determine whether to maintain the gold unit in the gold set or to remove the gold unit from the gold set.

For instance, at (306) the method determines whether the gold unit has been used for a predetermined maximum period of time. The predetermined maximum period of time can be defined or set based on the type of task and various other parameters associated with the crowdsourcing application. If the gold unit has been in the gold set for the predetermined maximum period of time, or longer, the gold unit can be removed from the gold set and no longer used as a gold unit (316).

Otherwise, the method can determine whether the gold unit has been used or provided to a worker a maximum number of times (308). For example, settings associated with the crowdsourcing application can specify that a gold unit can be used or provided to workers only a specified number of times. If the gold unit has been used the maximum number of times, the gold unit is removed from the gold set (316). By removing older gold units from the gold set, the method 300 provides a mechanism to prevent spammers from learning the gold units and gaming the system.

The method 300 can also be configured to remove a gold unit from the gold set if the gold unit becomes too subjective. A gold unit that requires a subjective response is not suitable to measure the accuracy of a worker due to the divergent responses available for the gold unit. Thus, it is desirable to remove gold units that are determined to be too subjective from the gold set.

For instance at (310), the method assesses the subjectiveness of the gold unit by determining a subjectivity metric for the gold unit. The subjectivity metric provides a numerical measure of the divergence of responses to the gold unit while the gold unit is in the gold set. Various statistical techniques can be performed on the responses to the gold unit to determine the subjectiveness metric associated with a gold unit.

For example, if the gold unit is a binary or Boolean gold unit (i.e. has two possible responses to the gold unit, e.g. true or false), the subjectiveness metric for a gold unit can be determined according to the following:

subjectiveness metric=2*min{Prob(answer is true),Prob(answer is false)}.

where Prob(answer is true) provides a probability measure of the number of “true” responses provided to the gold unit by the workers relative to the total number of responses to the gold unit and Prob(answer is false) provides a probability measure of the number of “false” responses provided to the gold unit by the workers relative to the total number of responses to the gold unit. While the present subject matter is discussed with reference to “true” and “false” Boolean responses, those of ordinary skill in the art, using the disclosures provided herein, should understand that other Boolean responses, such as “1” or “0”, “yes” or “no”, and other suitable Boolean responses can be provided without deviating from the scope of the present disclosure. Note that in the above example, the subjectiveness metric falls in the interval between 0 and 1. Typically, the greater the subjectiveness metric, the more divergent the answers are and the more subjective the gold unit.

In another example, the subjectiveness metric for the gold unit can be determined by analyzing the entropy of the probability distribution of the worker responses provided to the gold unit. For instance, the subjectiveness metric can be determined according to the following:

subjectiveness metric=−Σ_{each answer i}p(i)*ln p(i)

where p(i)=Prob (answer i is correct). The probability that an answer i is correct can be based on worker responses to similar units of work or units of work for related tasks. Other suitable statistical analysis techniques for analyzing the entropy of the probability distribution can be used without deviating from the scope of the present disclosure.

The method 300 can be configured to remove gold units from the gold set based on the subjectivity metric associated with the gold units. For instance, at (312), the subjectiveness metric is compared to a subjectiveness metric threshold. If the subjectiveness metric does not exceed the threshold, the gold unit can be maintained in the gold set (314). If the subjectiveness metric does exceed the threshold, the gold unit should be removed from the gold set for being too subjective (316).

While FIG. 3 is directed to a method 300 for determining when to remove gold units from the gold set, there is also a need to determine when to add new gold units to the gold set. The addition of new gold units to the gold set can depend on two factors: (1) the time it takes for a unit of work to achieve the required confidence level for selection to be included in the gold set; and (2) the need to replace an existing gold unit that has been removed from the gold set.

If a unit of work is selected for inclusion in the gold set before a gold set is removed, the unit of work can either be added into the gold set anyway or maintained in a queue of potential gold units for inclusion in the gold set. Another alternative is to dynamically increase the required confidence level threshold for a unit of work to achieve gold unit status such that less units of work are available for inclusion in the gold set.

If a gold unit has been removed from the gold set, for instance according to the method 300 of FIG. 3 discussed above, a new gold unit needs to be added to the gold set to replace the removed gold unit. FIG. 4 depicts an exemplary method for replacing a gold unit removed from the gold set with a new gold unit according to an exemplary aspect of the present disclosure.

At (402), a gold unit is removed from the gold set. The gold unit can be removed for any of the reasons set forth and discussed with reference to FIG. 3. Once the gold unit is removed, the method 400 can determine whether a new gold unit is available to replace the removed gold unit (404). For instance, the method can determine whether a gold unit is available in a queue of gold units waiting for inclusion in the gold set. If a gold unit is available, the gold unit can be added to the gold set (408).

If no new gold units are available, the method can include proactively polling a unit of work such that the unit of work achieves the necessary confidence level to be selected for inclusion in the gold set (306). In particular, suppose that a current confidence level of a unit of work is less than the required confidence level threshold for the unit of work to be selected for inclusion in the gold set. If (1−confidence level)(1−a) for the unit of work is greater than the required confidence level, the method can determine that receiving an additional response to the unit of work will likely result in the unit of work achieving the required confidence level. In this regard, the method 400 can proactively poll the unit of work such that a gold unit becomes available to replace a gold unit in the gold set.

As an alternative, the confidence level threshold for a unit of work to achieve gold unit status can be dynamically decreased such that more units of work are available for inclusion in the gold set. This should increase the probability that new gold units are available for inclusion in the gold set when a gold unit is removed from the gold set without having to proactively poll units of work.

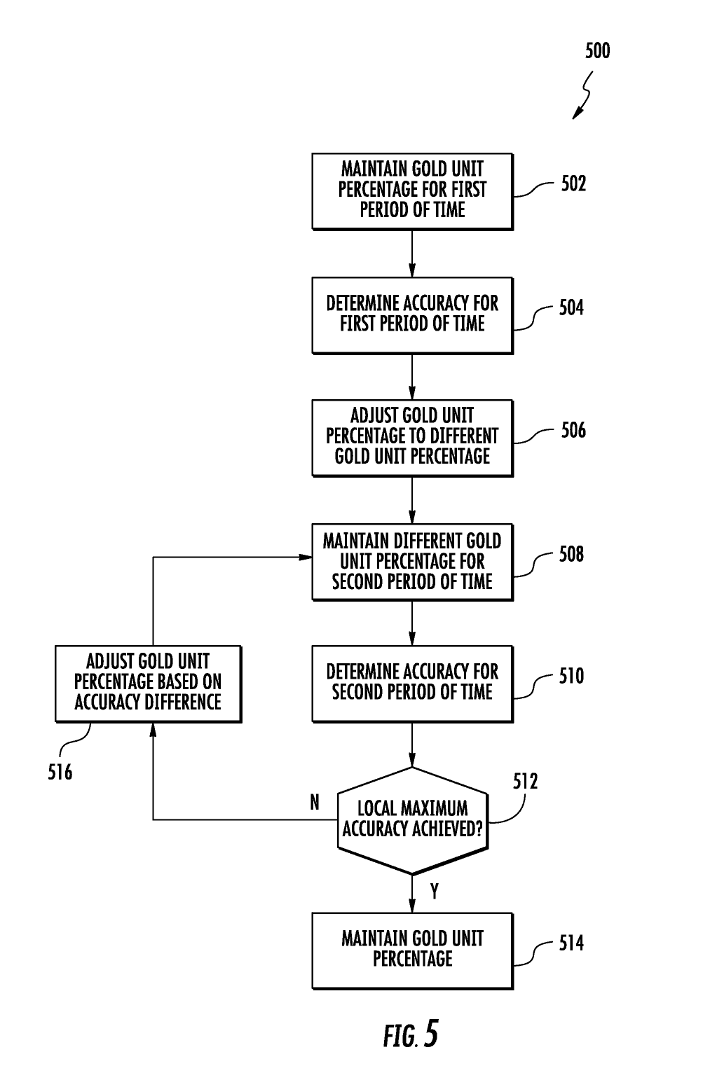

In addition to maintaining a dynamic gold set for a task, it can also be desirable to determine an optimum gold unit percentage for the task. FIG. 5 depicts an exemplary method 500 for determining an optimum gold unit percentage for a given task. At (502), a first gold unit percentage p is maintained for the task for a first period of time. The first gold unit percentage p can be a random gold unit percentage or other specified gold unit percentage. The accuracy a of the system is determined for the first period of time at (504). The accuracy a can be an overall accuracy associated with the crowdsourcing system, can be an accuracy associated with the task type, or can be an accuracy associated with workers completing the task, such as an average accuracy a of workers completing the task. At (506), the first gold unit percentage p is adjusted to a second gold unit percentage p′ by an amount Δp. Δp can be a random amount or other specified amount. The method maintains the second gold unit percentage p′ for a second period of time. The accuracy a′ for the second period of time is determined at (510).

At (512) the method determines whether a local maximum for the accuracy has been achieved. For instance, the accuracy a′ can be compared to the accuracy a and other accuracies logged during the calculation of the optimum gold unit percentage to determine if a′ is a maximum accuracy. If so, the gold unit percentage is maintained at the level used to achieve the maximum accuracy (514).

Otherwise, the gold unit percentage is adjusted based on the accuracy difference between a and a′ until a local maximum is achieved (516). For instance, in a particular embodiment, a standard gradient descent algorithm can be used to determine the local maximum for accuracy. The gradient can be calculated by calculating the accuracy change verses the gold unit percentage change (a′−a)/(p′−p). The gold unit percentage can be adjusted based on the gradient until a local maximum has been achieved. In this manner, the method 500 provides for the identification of an optimum gold unit percentage for a given task.

Referring back to FIG. 1, an exemplary application of delivering accuracy information to a requestor based on worker responses to gold units will be discussed in detail. In particular, the crowdsourcing platform 110 can log responses provided by the workers 130 to the units of work, including responses to gold units. The responses to the gold units can be used to compute an accuracy score for the worker. The accuracy score can be between 0 and 1, with 0 indicating that the worker answered none of the gold units correctly and 1 indicating the worker answered all of the gold units correctly. The accuracy score can be provided to the requestors 120 so that the requestors 120 can assess the reliability or quality of the worker responses.

In a particular application, the responses to the gold units can be used to compute an expected accuracy for a given number of duplicate units of work provided to the workers. For instance, when a requestor posts a new task to the crowdsourcing platform 110, an expected accuracy for the task can be computed based on the accuracy scores of the workers and the number of duplicate units of work provided to the workers, particularly if the responses to the units of work are aggregated through rules such as majority voting (i.e. the response to a given unit of work is the majority response to the unit of work from the workers) or weighted voting.

An exemplary calculation of expected accuracy is presented below. Suppose the average accuracy of the workers for a particular task is A and the duplication number is 3. The probability that the workers will provide a correct answer to the unit of work is as follows:

Pr(correct answer)=3*A*A(1−A)+A*A*A

This equation acknowledges that there are two ways a majority of 3 workers can answer a question correctly: (1) all workers answer the question correctly; and (2) only one worker answers the question incorrectly. The first term of the above equation stands for the probability that one worker answers the question incorrectly. The second term of the above equation stands for the probability that no workers answer the questions incorrectly. The estimated accuracy that the response to the unit of work will be correct is the sum of the first and second terms.

Similar calculations can be performed for varying levels of duplicate units of work. For instance, similar calculations can be performed for 2, 3, 4, 5, or more duplicate units of work. This estimated accuracy information can be provided to a requestor to assist the requestor in determining the level of duplicates for the task to achieve a desired accuracy. In this manner, worker responses to gold units for a given task can be used to provide accuracy estimate information to requestors for identical, similar, or related tasks.

Referring now to FIG. 6, an exemplary crowdsourcing system 600 for implementing the methods and processes discussed herein according to an exemplary embodiment of the present disclosure will be discussed in detail. Crowdsourcing system 600 includes a computing device 610 that can be coupled to one or more requestor computing devices 620 and worker computing devices 630 over a network 640. The network 640 can include a combination of networks, such as cellular network, WiFi network, LAN, WAN, the Internet, and/or other suitable network and can include any number of wired or wireless communication links

Computing device 610 can be a server, such as a web server, that exchanges information, including various tasks for completion, with requestor computing devices 620 and worker computing devices 630 over network 640. For instance, requestors can provide information, such as requests for tasks to be completed, from computing devices 620 to computing device 610 over network 640. Workers can provide responses to the tasks from computing devices 630 to computing device 610 over network 640. The computing device 610 can then track or maintain an appropriate reward or compensation for the workers for completing the task.

The requestor computing devices 620 and the worker computing devices 630 can take any appropriate form, such as a personal computer, smartphone, desktop, laptop, PDA, tablet, or other computing device. The requestor computing devices 620 and the worker computing devices 630 can include a processor and a memory and can also include appropriate input and output devices, such as a display screen, touch screen, touch pad, data entry keys, speakers, and/or a microphone suitable for voice recognition.

Similar to requestor computing devices 620 and worker computing devices 630, computing device 610 can include a processor(s) 612 and a memory 614. The processor(s) 612 can be any known processing device. Memory 614 can include any suitable computer-readable medium or media, including, but not limited to, RAM, ROM, hard drives, flash drives, or other memory devices. Memory 614 stores information accessible by processor(s) 612, including instructions 616 that can be executed by processor(s) 612. The instructions 616 can be any set of instructions that when executed by the processor(s) 612, cause the processor(s) 612 to provide desired functionality, such as executing a gold unit module 615 that automatically generates or identifies gold units and maintains a dynamic gold set according to exemplary aspects of the present disclosure. The instructions 612 can be software instructions rendered in a computer-readable form. When software is used, any suitable programming, scripting, or other type of language or combinations of languages may be used to implement the teachings contained herein. Alternatively, the instructions can be implemented by hard-wired logic or other circuitry, including, but not limited to application-specific circuits.

Memory 614 can also include data that may be retrieved, manipulated, or stored by processor(s) 612. For instance, memory 614 can store information associated with tasks, units of work, gold units, worker responses, worker accuracies, worker ratings and other information. Processor(s) 612 can be configured to execute instructions 616 stored in memory 614 to identify gold units and maintain a dynamic gold set based on information stored in memory 614.

The computing device 610 can communicate information to requestor computing devices 620 and worker computing devices 630 in any suitable format over network 640. For instance, the information can include HTML code, XML messages, WAP code, Java applets, xhtml, plain text, voiceXML, VoxML, VXML, or other suitable format.

While FIG. 6 illustrates one example of a crowdsourcing system 600 that can be used to implement the methods of the present disclosure, those of ordinary skill in the art, using the disclosures provided herein, will recognize that the inherent flexibility of computer-based systems allows for a great variety of possible configurations, combinations, and divisions of tasks and functionality between and among the components. For instance, the computer-implemented methods discussed herein may be implemented using a single server or processor or multiple such elements working in combination. Databases and other memory/media elements and applications may be implemented on a single system or distributed across multiple systems.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A computer-implemented method for identifying at least one gold unit for quality control in a crowdsourcing application, comprising:
receiving, by the one or more computing devices, a plurality of responses to a unit of work for a task;
monitoring, by the one or more computing devices, a confidence level of a unit of work for a task, the confidence level providing a measure of the probability that the most common response to the unit of work is correct, the confidence level being determined based at least in part on an accuracy associated with workers completing the unit of work;
comparing, by the one or more computing devices, the confidence level of the unit of work to a threshold value; and
selecting, by the one or more computing devices, the unit of work for inclusion in a gold set if the confidence level of the unit of work exceeds the threshold value;
providing, by the one or more computing devices, the unit of work to a worker for assessment of worker accuracy, and
receiving, by the one or more computing devices, the unit of work from the worker;
wherein the method comprises proactively polling the unit of work such that the confidence level of the unit of work exceeds the threshold value.

2. The computer-implemented method of claim 1, wherein the method comprises selecting, by the one or more computing devices, a work for inclusion in a gold set only if the responses to the unit of work meet a threshold consensus level.

3. The computer-implemented method of claim 1, wherein the confidence level is determined based at least in part on a Noisy-Or model.

4. The computer-implemented method of claim 1, wherein the accuracy associated with workers completing the unit of work comprises an average accuracy of all workers completing the unit of work or individual accuracies associated with individual workers completing the unit of work.

5. The computer-implemented method of claim 1, wherein the method comprises replacing, by the one or more computing devices, a gold unit in the gold set with the unit of work selected for inclusion in the gold set.

6. The computer-implemented method of claim 1, wherein the method comprises removing, by the one or more computing devices, a gold unit in the gold set if the gold unit has been used a predefined number of times or if the gold unit has been in the gold set for a predetermined period of time.

7. (canceled)

8. The computer-implemented method of claim 1, wherein the method further comprises:
monitoring, by the one or more computing devices, responses to a gold unit in the gold set from a plurality of workers;
determining, by the one or more computing devices, a subjectiveness metric of the gold unit based on the responses to the gold unit, the subjectiveness metric providing a measure of the divergence of responses to the gold unit from a plurality of workers; and
removing, by the one or more computing devices, the gold unit from the gold set based at least in part on the subjectiveness metric.

9. The computer-implemented method of claim 8, wherein the gold unit has a Boolean solution and the subjectiveness metric is determined based at least on the following:
subjectiveness metric=2*min{Prob(answer is true),Prob(answer is false)}.

10. The computer-implemented method of claim 8, wherein the subjectiveness metric is based on the entropy of the probability distribution of the answer set to the gold unit.

11. The computer-implemented method of claim 1,
wherein the method comprises:
maintaining, by the one or more computing devices, a first gold unit percentage for the task for a first period of time;
monitoring, by the one or more computing devices, the accuracy associated with the workers for the first period of time;
adjusting, by the one or more computing devices, the first gold unit percentage to a second gold unit percentage;
maintaining, by the one or more computing devices, the second gold unit percentage for a second period of time;
monitoring, by the one or more computing devices, the accuracy associated with the workers for the second period of time; and
adjusting, by the one or more computing devices, the gold unit percentage for the task based on the difference between the accuracy of the workers for the first period of time and the accuracy of the workers for the second period of time.

12. A crowdsourcing system, comprising:
one or more computing devices configured to provide one or more units of work of a task over a network for completion by remote workers;
one or more memory devices at the computing device configured to store data associated with responses to the one or more units of work by the remote workers;
one or more processors associated with the one or more computing devices configured to access the data stored in the memory and to select at least one unit of work for inclusion in a gold set;
the one or more computing devices configured to provide one or more gold units in the gold set over the network for completion by remote workers to assess quality of worker responses to the one or more units of work;
wherein the one or more processors executes computer-readable instructions stored in the one or more memory devices to perform the operations of:
determining a confidence level of a unit of work for the task, the confidence level providing a measure of the probability that the most common response to the unit of work is correct, the confidence level being determined based at least in part on an accuracy associated with workers completing the unit of work;
comparing the confidence level of the unit of work to a threshold value;
selecting the unit of work for inclusion in a gold set if the confidence level of the unit of work exceeds the threshold value;
providing the unit of work to a worker for assessment of worker accuracy; and
receiving the unit of work from the worker;
wherein the operations further comprise dynamically adjusting the threshold value to adjust a number of sold units selected for inclusion in the gold set.

13. The crowdsourcing system of claim 12, wherein the one or more processors executes computer-readable instructions stored in the one or more memory devices to perform the operations of:
monitoring responses to a gold unit in the gold set from a plurality of workers;
determining a subjectiveness metric of the gold unit based on the responses to the gold unit, the subjectiveness metric providing a measure of the divergence of responses to the gold unit from a plurality of workers; and
removing the gold unit from the gold set based at least in part on the subjectiveness metric.

14. The crowdsourcing system of claim 12, wherein the one or more processors executes computer-readable instructions stored in the one or more memory devices to perform the operations of:
maintaining a first gold unit percentage for a first period of time;
monitoring the accuracy associated with the workers for the first period of time;
adjusting the first gold unit percentage to a second percentage of gold units;
maintaining the second gold unit percentage for a second period of time;
monitoring the accuracy associated with the workers for the second period of time; and
adjusting the gold unit percentage based on the difference between the accuracy of the workers for the first period of time and the accuracy of the workers for the second period of time.

15. A computer implemented method, comprising:
monitoring, by the one or more computing devices, responses to a gold unit in the gold set from a plurality of workers;
determining, by the one or more computing devices, a subjectiveness metric of the gold unit based on the responses to the gold unit, the subjectiveness metric providing a measure of the divergence of responses to the gold unit from a plurality of workers; and
removing, by the one or more computing devices, the gold unit from the gold set based at least in part on the subjectiveness metric;
wherein the subjectiveness metric is based on an entropy of the probability distribution of an answer set to the gold set.

16. The computer-implemented method of claim 15, wherein removing the gold unit from the gold set based at least in part on the subjectiveness metric comprises:
comparing, by the one or more computing devices, the subjectiveness metric to a subjectiveness metric threshold; and removing the gold unit from the gold set if the subjectiveness metric exceeds the subjectiveness metric threshold.

17. The computer-implemented method of claim 15, wherein the gold unit has a Boolean solution and the subjectiveness metric is determined based at least on the following:
subjectiveness metric=2*min{Prob(answer is true),Prob(answer is false)}.

18.-20. (canceled)
